(19) United States
(12) Patent Application Publication
(10) Pub. No.: US 2003/0120721 A1
(43) Pub. Date: Jun. 26, 2003

(54) System and method for retrieving information from external systems

(76) Inventors: Patrick R. Clark, White House, TN (US); Frederick Martin, Hendersonville, TN (US); Charles S. Foster, Antioch, TN (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/028,579

(22) Filed: Dec. 19, 2001

(51) Int. Cl. G06F 15/16

(52) U.S. Cl. 709/203

(57) ABSTRACT

A computer based pivot method and system retrieves information for use by a requestor application. An information request is sent by the requester application to a master pivot program. The information request includes document information related to a requested information document. The document information is retrieved from the information request and document retrieval information is retrieved from a configuration database as a function of the document information. The requested information document is retrieved using the document retrieval information.

### TECHNICAL FIELD

The present invention relates generally to information retrieval, and more particularly, to a system and method for retrieving information from external systems.

### BACKGROUND

The purchase or lease of construction equipment is a very detailed process involving complicated financing decisions and financial documents. The process involves determining the type of financing available for the customer, as well as geographic factors. Additionally, depending on the type of financing and the geographic location of the customer, the number, type, as well as the terms of, the documents required vary.

In a typical sale or lease, the first step includes a quoting process. The quoting process involves a discussion with the customer, generally, including determining the equipment which the customer desires to lease or purchase and type and size of desired payment.

The second step is the credit process. The credit process involves requesting and receiving the customer credit scoring from a credit bureau. The credit scoring are used to determine the type of financing available to the customer. Other factors, may also a be used to determine the type of financing available, such as the customer's payment history on past purchases or leases.

Once the financing terms have been arranged, the financing documents must be prepared. As discussed above, the number and type of documents, as well as specific clauses or terms in the financing documents will vary. Factors includes customer, the lessor, the geographic location, and the type of financing. The lessor is generally a subsidiary of the financing company in a particular country. There may be more than one lessor in each country, based on different factors, e.g., currency of the transaction.

Historically, the financing documents were manually prepared by a finance analyst for each transaction. This manual process is time consuming and expensive. More recently, the finance analyst has manually prepared a list of the required financing documents identifying all of the needed parameters and/or terms. This list was then delivered to an automated remote documents computer system which generated the documents. However, the process of manually preparing the list and terms of the required financing documents is also time consuming and expensive. More recently, a computer program application has been developed which uses the information gathered during the quoting and credit processes, as well as information from other destinations or sources, in order to automatically prepare the list of financing documents. From the automatically prepared list, the automated remote documents computer system returns the documents.

However, during the process of preparing the list of documents, information must be gathered from a variety of sources including quoting and credit process computer applications and various legacy systems already existing and being used by the financial institution.

Whenever, a new system, i.e., a computer application, is added to the overall environment which requires information from these existing systems, a data communications link defining, inter alia, which information, the source, and the format of the information must be developed. For each new system, the data communications link must include a custom interface for the new system and a custom interface for each system with which the new system must communicate. This is a time consuming and expensive process.

The present invention is aimed at one or more of the problems addressed above.

### SUMMARY OF THE INVENTION

In one aspect of the present invention, a computer based method for retrieving information for use by a requestor application is provided. The method includes the step of sending, by the requestor application, an information request to a master pivot program. The information request includes document information related to a requested information document. The method further includes the steps of retrieving the document information from the information request and retrieving document retrieval information from a configuration database as a function of the document information. The document retrieval information includes a destination system. The method also includes the steps of sending the document retrieval information and the information request to a destination pivot program coupled to the destination system, retrieving the requested information document from the destination system by the destination pivot program, and sending the requested information document to the requester application.

In another aspect of the present invention, a computer based system for retrieving information for use by a requester application is provided. The system includes a requestor application for generating an information request. The information request includes document information related to a requested information document. The system also includes a configuration database containing document retrieval information and a master pivot program coupled to the requestor application and the configuration database. The master pivot program receives the information request, retrieves the document information from the information request, and retrieves document retrieval information for the requested information document from the configuration database as a function of the document information. The master pivot program also retrieves the requested information document from a destination system using the document retrieval information.

### BRIEF DESCRIPTION OF THE DRAWINGS

FIG. 1 is a flow diagram of a transaction process including a document preparation process, according to an embodiment of the present invention;

FIG. 2 is a block diagram of a system for automatically creating a list of financing documents for a transaction and automatically providing the documents;

FIG. 3 is a block diagram of a system for retrieving information from external systems for use by a requester application, according to an embodiment of the present invention;

FIG. 4 is a block diagram of a computer program product for retrieving information for use by a requester application, according to an embodiment of the present invention; and,

FIG. 5 is a first flow diagram of a method for automatically retrieving information from external systems for use by a requestor application, according to an embodiment of the present invention.

### DETAILED DESCRIPTION

With reference to the drawings, and in operation, the present invention provides a computer based system 200 and a method 400, 500 for automatically retrieving information from external systems for use by a requestor application. The present invention is described within an overall system of providing financial documents for the sale or leasing of construction equipment. This is for purposes of explanation only, and the present invention is not limited to such an application.

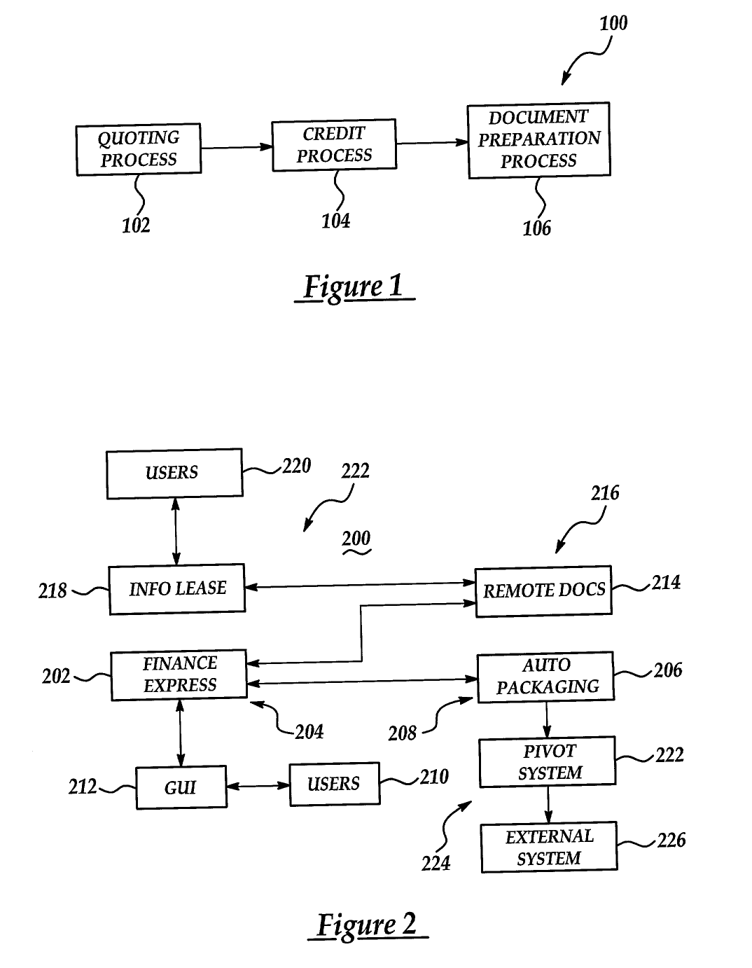

With specific reference to FIG. 1, the present invention is particularly adapted for use during the creation of a purchasing or leasing transaction 100 for construction equipment. As described above, there are three basic functions during the creation process: a quoting process (flow block 102), a credit process (flow block 104), and a document preparation process (flow block 106).

Generally, a customer desires to purchase or lease one or more pieces of construction equipment. The customer contacts a sales agent, who may be located at either a dealer of the construction equipment or at a financing company.

In the quoting process 102, the agent works with the customer and determines the equipment which the customer wished to purchase or lease and a maximum or desired monthly payment.

In the credit process 104, the sales agent requests a credit scoring for the customer from a credit bureau. This information, along with other information regarding the customer's history with the financing company, is used to determine whether to extend credit to the customer for the purchase or lease of the equipment and, if so, under what terms.

During the quoting and credit processes 102, 104, the sales agent requests and receives from the customer, transaction information. As described below, the agent enters this information into the system 200.

With specific reference to FIG. 2, the computer system 200 for automatically creating a list of financing documents for a transaction, according to an embodiment of the present invention, will now be described.

The system 200 includes a automated finance computer application 202 implemented on a computer system (not shown) located at a first location 204. An auto-packaging computer application 206 implemented on a second computer system (not shown). The auto-packaging computer application 206 is coupled to the automated finance computer application 202 and is located at a second location 208.

The auto-packaging computer application 206 is adapted to receive a request for a decision criteria document from the automated finance computer application 202 and prepare the decision criteria document. The decision criteria document includes a plurality of data fields to be completed.

As discussed below, the automated finance computer application 202 completes the data fields and sends the completed decision criteria document back to the auto-packaging computer application 206.

Based on the completed data fields of the decision criteria document, the auto-packaging computer application 206 selects a required set of documents and prepares the list of financing documents.

Preferably, a user 210 interacts via a graphic user interface 212 to input the transaction information during the quoting and credit processes 102, 104. In response to a user request, the automated finance computer application 202 sends the request for the decision criteria document to the auto-packaging computer application 206.

In response to receiving the request for a decision criteria document, the auto-packaging computer application 206 is adapted to request initial information from the automated finance computer application in response to receiving the request for a decision criteria document and to receive the initial information from the automated finance computer application, wherein the data fields of the decision criteria document are determined as a function of the initial information.

Preferably, the initial information is determined or contained in the transaction information and gleaned automatically by the automated finance computer application 202. In one embodiment, the initial information includes a contract type, a country code, and a lessor number. The contract type may includes, but not limited to a lease, a loan, an installment contract, or a governmental lease.

Preferably, the decision criteria document is in extensible markup language (XML). Additionally, the automated finance computer application 202 is adapted to allow the user to override the required set of documents. Preferably, the required set of documents includes a primary document and at least one supporting document. Each document in the list of financing documents includes:

a document name,

a number of copies, and

a simplex/duplex code.

Additionally, each document may include:

a document type (primary contract or supporting paper),

a description,

an association with other documents, and,

an effective date and an inactive date (where applicable).

Associated with each document are also a set of selection rules which determine the conditions under which the document is to be included in the documentation package. The selection rules are based upon values of specific data elements in the deal or agreement. Preferably, all of the specifics and rules of the documents are contained in tables. Documents can be added or inactivated as needed. Old rules may also be added or inactivated as required.

For example, form AT0037 is an Attachment that describes the equipment for which the contact is being drafted. The form is used when more than eight (8) pieces of equipment are at issue. Thus, the selection criteria rule is written as indicated below:

| Field Name | Operator | Value1 |
|---|---|---|
| Num_Assets | > | 8 |

The value of Num_Assets is received from the automated finance computer application 202.

In another example, form CISCDIR is an insurance form used when insurance is sold directly to the customer without a licensed dealer. The selection criteria rule is indicated below:

| Field Name | Operator | Value1 |
|---|---|---|
| dlr_state | <> | TX |
| dlr_insurance_status | = | UNLICENSED |
| customer_state | not in list | HI, AK |
| cat_insurance | = | true |
| self_insured | = | false |

The auto-packaging computer application 206 sends the list of required documents to the automated finance computer application 202.

As shown, the system 200 further includes a remote docs computer application 214 implemented on a third computer system which may be located at a third location 216.

In one embodiment, the automated finance computer application 202 sends the list to the remote docs computer application 214. The remote docs computer application is an automatic document delivery system which receives the list, automatically generates the required documents and returns the required documents to the user 210 via the automated finance computer application 202 and the GUI 212.

Additionally, an automated lease computer application 218 may be provided for use by additional users 220 located at a fourth location 222. The additional users 222 enter information about a transaction into the automated lease computer application 218. For these transactions, the list of required documents is prepared manually and input into the automated lease computer application 218. The automated lease computer application 218 sends the list of required documents to the remote docs computer application 214. As above, the remote docs computer application 214 prepares the required documents and sends them back.

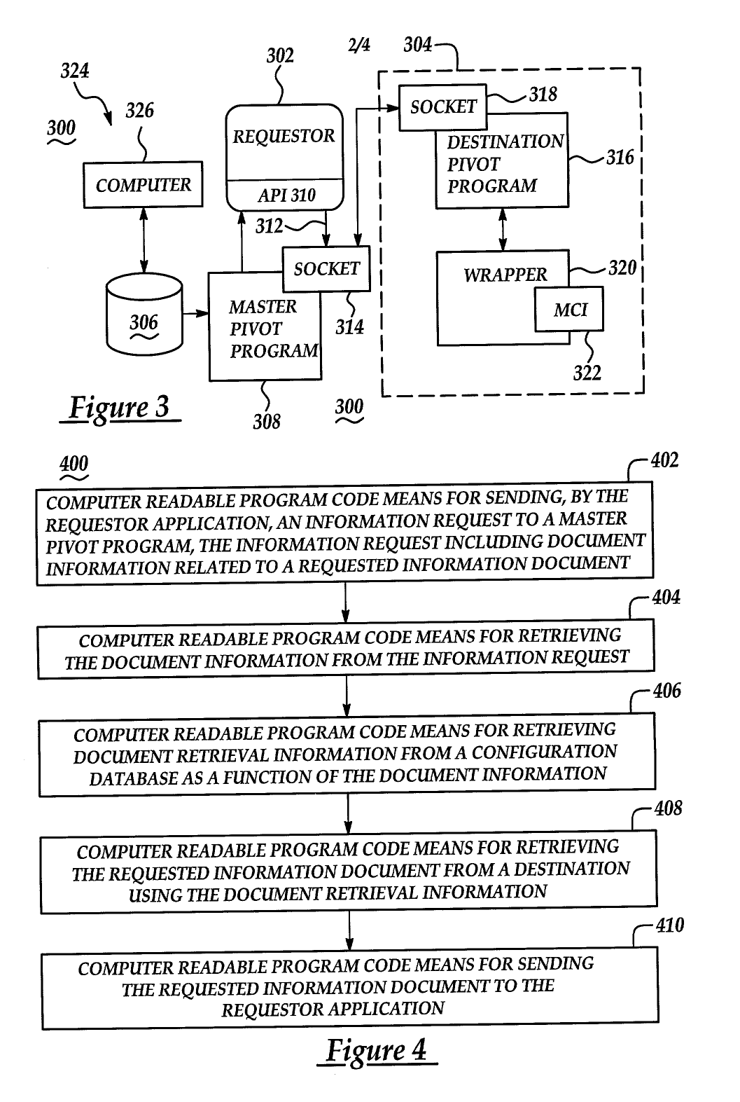

With reference to FIG. 3, the present invention provides a computer based system 300 for retrieving information for use by a requester application 302. The requestor application 302 refers to one or more systems or computer application in a larger environment which requires information from another system in the larger environment. For example, in the transaction 100 environment described above, the automated finance computer application 202 may require information related to a customer's past payment history. This information may be stored in a system external to the automated finance computer application 202. As described below, the system 300 provides automatically retrieves the information from a destination or external system 304.

The requestor application 302 generates an information request. The information request is preferably an extensible markup language document (XML) and includes document information related to a requested information document. XML is a pared-down, simplified version of the Standard Generalized Markup Language. SGML is a meta-language for writing Document Type Definitions (DTD). A DTD describes how a document conforming to it should be marked up, e.g., the structural tags that may occur in the document, the ordering of the tags, and a host of other features.

The requested information document contains the information requested by the requestor application 302.

A configuration database 306 contains document retrieval information. Preferably, the document retrieval information includes a destination 304, i.e., the location of the requested document, dimensions of the document, and a MCI command (see below).

Preferably, the configuration database 306 is a relational database, such as Oracle. The configuration database 306 also preferably includes routing rules for a plurality of requestor applications 302 and destination applications 304.

A master pivot program 308 is coupled to the requester application 302 and the configuration database 306. The master pivot program 308 receives the information request, retrieves the document information from the information request, and retrieving document retrieval information for the requested information document from the configuration database 306 as a function of the document information. The master pivot program 308 retrieves the requested information document from a destination system (304) using the document retrieval information.

In one embodiment, the master pivot program 308 is adapted to retrieve a document type tag from the XML document and to retrieve the dimensions from the configuration database as a function of the document type tag. The master pivot program 308 thereafter retrieves dimension values from the XML document.

In one embodiment, the master pivot program 308 is adapted to deliver the requested information document to the requester application 302. Preferably, the destination pivot program 318 is adapted to send the requested information document to the master pivot program 308 and the master pivot program 308 is adapted to send the requested information document to the requester application 302.

In one embodiment, the requester application 302 includes an application program interface (API) 310. An API is a set of routines, protocols and tools for building software applications. The requestor application is adapted to call the API to send the information request to the master control interface. The API creates a structure of routine information. An IPC, or interprocess communication is a capability supported by some operating systems that allows one process to communicate with another process. The processes can be running on the same computer or on different computers connected through a network. IPC enables one application to control another application, and for several applications to share the same data without interfering with one another.

The API 310 is coupled to the master pivot program 308 through a socket 314.

The destination application or source 304 preferably includes a destination pivot program 316, a destination socket 318, a wrapper computer program application 320, and a master control interface (MCI) 322. The destination socket 318 allows communication between the master pivot program 308 and the destination pivot program 318.

The master control interface (MCI) 322 is coupled to the destination pivot program 318 and is adapted to receive the document retrieval information and the information request and to process the information request. The wrapper computer program application 320 is adapted to pass the information request from destination pivot program 318 to the MCI 322.

A configuration tool 324 implemented on a computer 326 is used to maintain the configuration database 306.

With reference to FIG. 4, the system 200 is implemented in a computer program product 300 for automatically creating a list of financing documents for a transaction. The computer readable program code includes:

computer readable program code means 402 for sending, by the requester application, an information request to a master pivot program, the information request including document information related to a requested information document;

computer readable program code means 404 for retrieving the document information from the information request;

computer readable program code means 406 for retrieving document retrieval information from a configuration database as a function of the document information;

computer readable program code means 408 for retrieving the requested information document from a destination using the document retrieval information; and,

computer readable program code means 410 for sending the requested information document to the requester application.

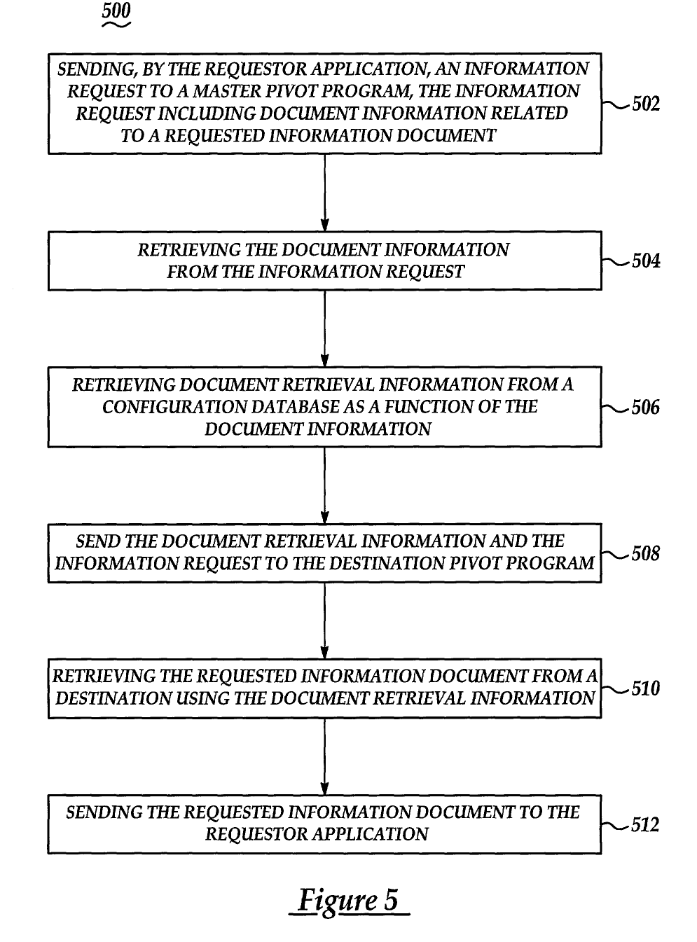

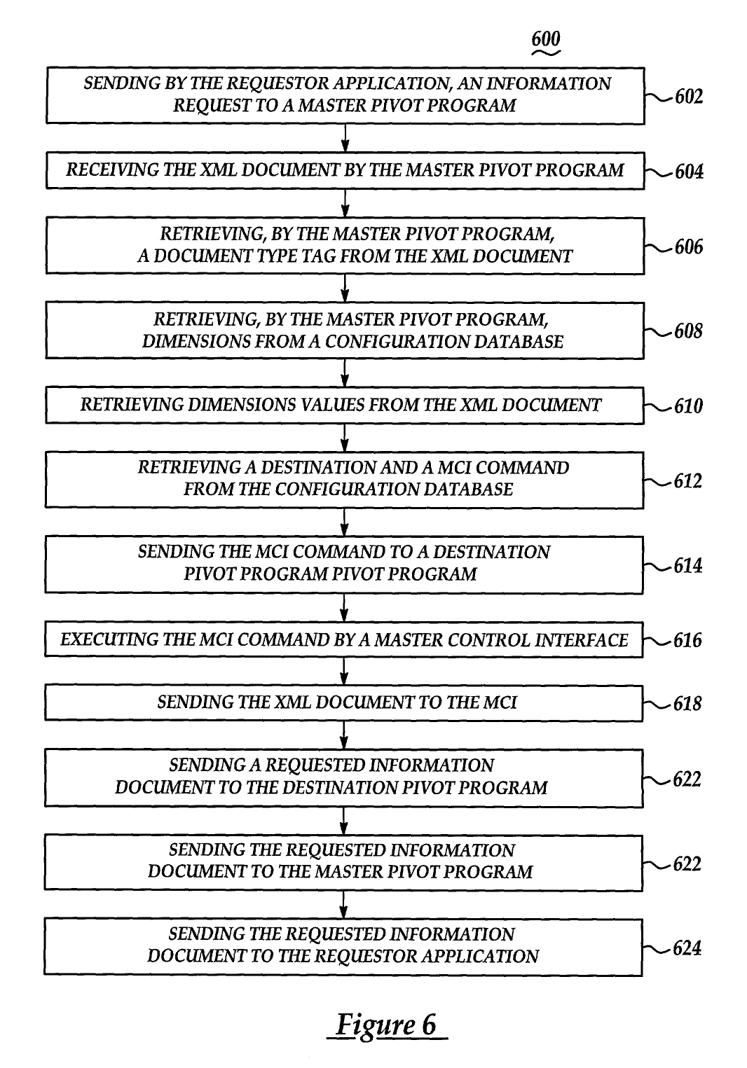

With reference to FIG. 5, a method 500 for retrieving information for use by a requestor application, according to one embodiment of the present invention is illustrated.

In a first process block 502, an information request is sent by the requestor application 302 to the master pivot program 308. The information request includes document information related to a requested information document.

In a second process block 504, the document information is retrieved from the information request. In a third process block 506, document retrieval information is retrieved from a configuration database 306 as a function of the document information. The document retrieval information including a destination system 304.

In a fourth process block 508, the document retrieval information and the information request is sent to a destination pivot program 316 coupled to the destination system 304.

In a fifth process block 510, the requested information document is retrieved from the destination system 304 by the destination pivot program 316. In a sixth process block 512, the requested information document is sent to the requestor application 302.

With reference to FIG. 6, a method 600 for retrieving information for use by a requester application, according to another embodiment of the present invention is illustrated. In a seventh process block 602, the requester application 302 sends an information request to a master pivot program 308. The information request is an extensible markup language (XML) document. In an eighth process block 604, the XML document is received by the master pivot program 308. In a ninth process block 606, the master pivot program 308 retrieves a document type tag from the XML document.

In a tenth process block 608, the master pivot program 308 retrieves dimensions from the configuration database 306 as a function of the document type tag. In an eleventh process block 610, dimension values are retrieved from the XML document. In a twelfth process block 612, a destination and a MCI command are retrieved from the configuration database 306. The MCI command is sent to the destination pivot program 316 located at the destination 304 in a thirteenth process block 614.

In a fourteenth process block 616, the MCI command is executed by the master control interface (MCI) 322 located at the destination pivot program 316.

In a fifteenth process block 618, the XML document is sent to the MCI 322. In a sixteenth process block 620, the requested information document is sent by the MCI 322 to the destination pivot program 316 as a function of the MCI command and the XML document.

In a seventeenth process block 622, the requested information document is sent by the destination pivot program 302 to the master pivot program 308.

In an eighteenth process block 624, the requested information document is sent by the master pivot program 308 to the requestor application 302.

### INDUSTRIAL APPLICABILITY

With specific reference to FIG. 1, the present invention provides a system and method 200, 400, 500 for automatically creating a list of financing documents for a transaction. The system and method 200, 400, 500, in practice, are generally part of a sale or lease transaction for, e.g., construction equipment. The customer (purchaser or lessee) interacts with an employee (sales agent) of a dealer, a financial company or the manufacturer.

As described above, there are generally three steps to the transaction: the quoting process, the credit process and the document preparation process.

In the quoting process, the customer and the sales agent discuss the type and number of equipment, the type of contract, and the maximum size payment the client desires. After these are determined, the agent performs a credit check on the customer to determine whether or not to extend the desired credit to the customer. Past customer conduct with respect to payment history to the financial company may also be considered. After the credit process, the transaction documents needs to be prepared. The auto-packaging computer application 204 generates a list of the required documents using information gathered during the quoting process and the credit process. Additional information regarding the customer may be retrieved from other systems, e.g., the customer's past credit history with the finance company. After receiving the list generated by the auto-packaging computer application 204, the automated finance computer application 202 sends the list to the remote documents computer application 214. The remote documents computer application 214 retrieves the documents and delivers the documents to the automated finance computer application.

During this process, an application, such as the automated finance computer application 202 may require information from another application or database. The retrieval of this information is performed invisibly to the user. The present invention provides a system and method for retrieving such information. As new systems are integrated into the overall environment, either as new applications, or information contained within the new system is needed, there is no need to write a custom interface between the new system and each of the other systems. Through the master pivot program 308, the present invention provides a method and system for retrieving information from any system within the environment. Each application needs only to be in data communication with the master pivot program 308.

Other aspect and features of the present invention can be obtained from a study of the drawings, the disclosure, and the appended claims.

What is claimed is:

1. A computer based method for retrieving information for use by a requester application, comprising the steps of:
sending, by the requestor application, an information request to a master pivot program, the information request including document information related to a requested information document;
retrieving the document information from the information request;
retrieving document retrieval information from a configuration database as a function of the document information, the document retrieval information including a destination system;
sending the document retrieval information and the information request to a destination pivot program coupled to the destination system;
retrieving the requested information document from the destination system by the destination pivot program; and, sending the requested information document to the requester application.

2. A computer based method, as set forth in claim 1, wherein the information request is an extensible markup language document.

3. A computer based method, as set forth in claim 1, wherein the step of sending the information request to the master pivot program includes the step of calling an application program interface (API).

4. A computer based method, as set forth in claim 3, further including the step of creating, by the API, a structure of routing information.

5. A computer based method, as set forth in claim 4, wherein the step of sending the information request to the master pivot program includes the step of sending the information request to the master pivot program through a socket.

6. A computer based method, as set forth in claim 1, including the step receiving the document retrieval information and the information request by a master control interface (MCI) coupled to the destination pivot program, the master control interface being adapted to process the information request.

7. A computer based method, as set forth in claim 6, wherein the MCI includes a wrapper computer program application adapted to pass the information request from the MCI to the destination system.

8. A computer based method, as set forth in claim 1, wherein the configuration database is a relational database.

9. A computer based method, as set forth in claim 1, wherein the configuration database includes routing rules for a plurality of requestor applications and destination applications.

10. A computer based method, as set forth in claim 1, including the step of providing a configuration tool for maintaining the configuration database.

11. A computer based method for retrieving information for use by a requestor application, comprising the steps of:
sending, by the requestor application, an information request to a master pivot program, the information request being an extensible markup language (XML) document;
receiving the XML document by a master pivot program;
retrieving, by the master pivot program, dimensions from a configuration database as a function of the XML document;
retrieving a destination and a MCI command from the configuration database;
retrieving a requested information document from the destination in response to the MCI command; and,
sending the requested information document to the requestor application.

12. A computer based method, as set forth in claim 11, including the step of retrieving, by the master pivot program, a document type tag from the XML document and wherein the master pivot program retrieves the dimensions from the configuration database as a function of the document type tag.

13. A method, as set forth in claim 12, including the step of retrieving dimension values from the XML document.

14. A method, as set forth in claim 11, including the steps of:
executing the MCI command by a master control interface (MCI) located at the destination pivot program; and,
sending the XML document to the MCI, wherein the requested information document is determined by the MCI as a function of the MCI command and the XML document.

15. A method, as set forth in claim 11, wherein the step of sending the requested information document to the requestor application includes the steps of:
sending the requested information document, by the destination pivot program, to the master pivot program; and,
sending the requested information document, by the master pivot program, to the requester application.

16. A computer based method, as set forth in claim 11, wherein the step of sending the information request to the master pivot program includes the step of calling an application program interface (API).

17. A computer based method, as set forth in claim 16, further including the step of creating, by the API, a structure of routing information.

18. A computer based method, as set forth in claim 17, wherein the step of sending the information request to the master pivot program includes the step of sending the information request to the master pivot program through a socket.

19. A computer based method, as set forth in claim 11, including the step receiving the document retrieval information and the information request by a master control interface (MCI) coupled to the destination pivot program, the master control interface being adapted to process the information request.

20. A computer based method, as set forth in claim 19, wherein the MCI includes a wrapper computer program application adapted to pass the information request from the MCI to the destination system.

21. A computer based method, as set forth in claim 11, wherein the configuration database is a relational database.

22. A computer based method, as set forth in claim 11, wherein the configuration database includes routing rules for a plurality of requestor applications and destination applications.

23. A computer based method, as set forth in claim 11, including the step of providing a configuration tool for maintaining the configuration database.

24. A computer based method for retrieving information for use by a requestor application, comprising the steps of:
sending, by the requester application, an information request to a master pivot program, the information request being an extensible markup language (XML) document;
receiving the XML document by the master pivot program;
retrieving, by the master pivot program, a document type tag from the XML document;
retrieving, by the master pivot program, dimensions from a configuration database as a function of the document type tag;
retrieving dimension values from the XML document;
retrieving a destination and a MCI command from the configuration database;
sending the MCI command to a destination pivot program located at the destination;
executing the MCI command by a master control interface (MCI) located at the destination pivot program;
sending the XML document to the MCI;
sending a requested information document, by the MCI, to the destination pivot program as a function of the MCI command and the XML document;
sending the requested information document, by the destination pivot program, to the master pivot program; and,
sending the requested information document, by the master pivot program to the requestor application.

25. A computer based system for retrieving information for use by a requestor application, comprising:
a requestor application for generating an information request, the information request including document information related to a requested information document;
a configuration database containing document retrieval information; and,
a master pivot program, coupled to the requestor application and the configuration database, for receiving the information request, retrieving the document insformation from the information request, and retrieving document retrieval information for the requested information document from the configuration database as a function of the document information and for retrieving the requested information document from a destination system using the document retrieval information.

26. A computer based system, as set forth in claim 25, wherein the master pivot program is adapted to deliver the requested information document to the requestor application.

27. A computer based system, as set forth in claim 25, wherein the document retrieval information includes a destination and a master control interface command.

28. A computer based system, as set forth in claim 27, including a master control interface adapted to execute the master control interface command.

29. A computer based system, as set forth in claim 25, wherein the information request is in extensible markup language format.

30. A computer based system, as set forth in claim 25, including an application program interface (API), wherein the requester application is adapted to call the API to send the information request to the master control interface.

31. A computer based system, as set forth in claim 30, including a structure of routine information created by the API.

32. A computer based system, as set forth in claim 31, including a socket coupled between the master pivot program and the requestor application.

33. A computer based system, as set forth in claim 25, including a master control interface (MCI) coupled to the destination pivot program, the MCI being adapted to receive the document retrieval information and the information request by and to process the information request.

34. A computer based system, as set forth in claim 33, wherein the MCI includes a wrapper computer program application adapted to pass the information request from the destination pivot program to the MCI.

35. A computer based system, as set forth in claim 25, wherein the configuration database is a relational database.

36. A computer based system, as set forth in claim 25, wherein the configuration database includes routing rules for a plurality of requestor applications and destination applications.

37. A computer based system, as set forth in claim 25, including a configuration tool for maintaining the configuration database.

38. A computer based system for retrieving information for use by a requester application, comprising:
a requestor application for generating an information request, the information request being an extensible markup language (XML) document;
a configuration database containing document retrieval information; and,
a master pivot program, coupled to the requestor application and the configuration database, for receiving the XML document, retrieving the document information from the information request, and retrieving dimensions, a destination and a MCI command from the configuration database as a function of the document information, for retrieving the requested information document from a destination system in response to the MCI using the document retrieval information, and for sending the requested information document to the requester application.

39. A computer based system, as set forth in claim 38, wherein the master pivot program is adapted to retrieve a document type tag from the XML document and to retrieve the dimensions from the configuration database as a function of the document type tag.

40. A computer based system, as set forth in claim 39, wherein the master pivot program (308) is adapted to retrieve dimension values from the XML document.

41. A computer based system, as set forth in claim 38, including a master control interface (MCI) coupled to the destination pivot program, the MCI being adapted to execute the MCI command.

42. A computer based system, as set forth in claim 41, wherein the MCI determines the requested information document as a function of the MCI command and the XML document.

43. A computer based system, as set forth in claim 38, wherein the destination pivot program is adapted to send the requested information document to the master pivot program and the master pivot program is adapted to send the requested information document to the requester application.

44. A computer based system, as set forth in claim 38, including an application program interface (API) coupled to the requestor application, wherein the requester application is adapted to call the API to send the information request to the master pivot program.

45. A computer based system, as set forth in claim 44, including a structure of routing information created by the API.

46. A computer based system, as set forth in claim 45, including a socket coupled to the master pivot program, wherein the requester application is adapted to send the information request to the master pivot program through the socket.

47. A computer based system, as set forth in claim 38, including the step receiving the document retrieval information and the information request by a master control interface (MCI) coupled to the destination pivot program, the master control interface being adapted to process the information request.

48. A computer based system, as set forth in claim 47, including a wrapper computer program application adapted to pass the information request from the destination pivot program to the MCI.

49. A computer based system, as set forth in claim 38, wherein the configuration database is a relational database.

50. A computer based system, as set forth in claim 38, wherein the configuration database includes routing rules for a plurality of requester applications and destination applications.

51. A computer based system for retrieving information for use by a requester application, comprising:
a requestor application for generating an information request, the information request, the information request being an extensible markup language (XML) document;
a configuration database containing document retrieval information; and,
a master pivot program, coupled to the requestor application and the configuration database, for receiving the XML document and retrieving a document type tag from the XML document, for retrieving dimensions, a destination, and a MCI command from the configuration database as a function of the XML document, and for sending the MCI command to a destination pivot program located at the destination; and
a master control interface (MCI) located at the destination pivot program, the MCI being adapted to execute the MCI command, retrieve a requested information document as a function of the MCI command, and responsively send a requested information document to the destination pivot program, wherein the destination pivot program is adapted to send the requested information document to the master pivot program and the master pivot program is adapted to send the requested information document to the requester application.

52. A computer program product for retrieving information for use by a requester application, the computer readable program code comprising:
computer readable program code means for sending, by the requester application, an information request to a master pivot program, the information request including document information related to a requested information document;
computer readable program code means for retrieving the document information from the information request;
computer readable program code means for retrieving document retrieval information from a configuration database as a function of the document information;
computer readable program code means for retrieving the requested information document from a destination using the document retrieval information; and,
computer readable program code means for sending the requested information document to the requestor application.
